(19) United States
(12) Patent Application Publication
(10) Pub. No.: US 2007/0130223 A1
(43) Pub. Date: Jun. 7, 2007

(54) Method for synchronizing information

(76) Inventors: Erkki Savilampi, Lempaala (FI); Jukka-Pekka Hyvarinen, Tre (FI); Kim Simelius, Tre (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/293,887

(22) Filed: Dec. 2, 2005

(51) Int. Cl. G06F 17/30

(52) U.S. Cl. 707/203

(57) ABSTRACT

A method for synchronizing an event in a first datastore and a second datastore. The method comprises the steps of selecting a first datastore comprising a plurality of events, selecting a second datastore, and providing a synchronization setting for an event in the plurality of events so as to indicate how synchronization between the first datastore and the second datastore is to be performed with respect to the event. The synchronization setting may indicate that a corresponding event in the second datastore is to be synchronized with the event in the first datastore, or that the event in the first datastore is to be synchronized with the corresponding event in the second datastore, or the synchronization setting may indicate that the first datastore obtains from the second datastore an update to the information of the event, adds the update to the event, and synchronizes the event based on the updated event.

### TECHNICAL FIELD

The present invention relates to data synchronization. More specifically, the present invention pertains to synchronizing information between two or more datastores using so-called personal information management (PIM) software. The invention is also applicable in managing scheduled events and sharing information of the events.

### Background Art

Personal information management (PIM) software is any application that keeps track of personal information such as emails, address books, calendars, task lists, wish lists, schedules, notes, etc. Devices like personal computers (PCs), personal digital assistants (PDAs), communicators and smart phones are commonly equipped with PIM software for editing, organizing and storing personal information. Some widely used PIM software 15 suites, such as MICROSOFT® OUTLOOK® and LOTUS NOTES®, are equipped with synchronization functionality that allows for synchronizing information between two PIM datastores, such as a datastore in a client device and a corresponding datastore in a network server, or a datastore in a client device and another datastore in another client device (e.g. between a PC and a PDA), and sharing and updating information among a plurality of client devices and/or servers. Synchronization between a mobile device and a PC can be performed in a similar manner as the synchronization between a PC and a PDA. Software such as NOKIA® PC Suite for NOKIA® Phones is capable of handling wireless synchronization.

In data synchronization, if two or more client devices (or datastores) have different data concerning a particular event (an event can be taken as a datastore entry comprising one or more data fields), the event stored in one datastore will “win” the synchronization (i.e. sending own data of the event to other datastores to override the event entry in other datastores) and the same event stored in other datastores will “lose” (i.e. receive the event data from the wining datastore and lose their own). Normally in PIM applications, there is a default setting or rule that determines which datastore “wins” the synchronization. A commonly used default rule is “New Data Replaces Old Data.” Under this rule, if an event, existing in datastores of client A and client B, was modified in client A's datastore but not in client B's datastore, the modified data of the event are synchronized from client A to client B because client A's datastore has a newer version of the event, so that client A “wins” the synchronization because of a later time stamp.

Some synchronization software involving a mobile client device and a PC, such as NOKIA® PC Suite for NOKIA® Phones, allows a user to choose a “winner” using settings of “Mobile Client Always Wins” or “PC Always Wins.” However, these rules, once set, are applied to all the event entries in the mobile client's and PC's datastores, not that one event can be synchronized according to one rule and another event according to another rule.

Under some complicated circumstances, it may be necessary to let the synchronization of a particular event occur against a preset rule, so that the chosen “winner” does not necessarily win the synchronization. Sometimes it may be necessary to suspend a synchronization setting for a specified time period. Following are some examples illustrating situations that require special attention to the synchronization setting.

A first example of such situations is that, when a user, having synchronous clients A and B, edits data of an event in client B, and then accepts and saves the change but later realizes that the newly entered data are useless, obsolete or otherwise wrong. The user will need to alter the synchronization setting so that the modified event containing wrong data is not synchronized from client B to client A.

A second example of such situations is that a user wants to save changes made on both client A and client B. Under the “New Data Replaces Old Data” or “Mobile Client (or PC) Always Wins” setting, only one set of data is used for synchronization. Preserving the event data edited in both client A and client B at the synchronization is not possible. This situation may become more complicated, especially, when there are two users (e.g. a primary user on a remote client B and a delegate of the user on a local client A) having the access to the same event.

A third example of such situations is in organizing and handling an event such as a meeting that involves multiple parties. The information sharing among the meeting participants is inconvenient or inefficient if it is done by means of point-to-multipoint synchronization. A meeting request and related event data (e.g. date, time, subject, participants, file attachments, etc.) are typically managed by a meeting organizer (and/or a delegate of the organizer who also has access to the event). As seen in FIG. 1, with prior art PIM software such as MICROSOFT® OUTLOOK®, a meeting organizer creates a meeting event in the organizer's datastore (the datastore may be located in the organizer's client 10 or in an email/PIM file server 20), and then sends a meeting request (normally via email distribution) to the intended participants (Attendees 1, 2, 3, and 4, etc.). A participant who accepts the invitation has a corresponding event in the datastore of his/her own client (31, 32, 33 or 34) or in the server 20, created either by the participant or by the organizer. The organizer sends updates (if any) later on by editing the data in the fields of the event entry in his/her own datastore, and pressing a “Send Update” button (or the like) so that the updated entry is sent to a plurality of participants simultaneously. A participant who wants to submit additional information about the meeting has two options: (1) send a separate email to all or selected participants, or (2) send the information via email to the organizer and request that the organizer includes the information in the next update.

Neither of the above options is ideal. For the first option, sending information to other participants by separate emails makes it hard to track the information, because a link between the event and the additional information is never created. For the second option, sending data to the organizer for an update and distribution can be untimely because the other participants will have to wait till the next update to see the changes. These shortcomings become especially annoying if a number of meeting participants need to provide materials in advance and the meeting agenda is changed multiple times. Also, if some of the meeting-related files are distributed via e-mails and others via event updates, the materials concerning one particular event can be scattered in several different places.

Therefore, what is needed is a method for sharing and updating information of an event between two or more datastores that store the event. The method includes a list of synchronization settings. According to the method, a user who manages and updates an event in a datastore can select a synchronization setting for the event, so that other datastores share the updated information of the entry through synchronization according to the setting.

### SUMMARY OF THE INVENTION

The invention relates to synchronizing an event in a first datastore and a second datastore, and sharing and updating event information among a plurality of datastores.

In a first aspect of the invention, a method is provided. The method comprises the steps of selecting a first datastore comprising a plurality of events, selecting a second datastore, and providing a synchronization setting for an event in the plurality of events so as to indicate how synchronization between the first datastore and the second datastore is to be performed with respect to the event. The synchronization setting may indicate that a corresponding event in the second datastore is to be synchronized with the event in the first datastore, or the synchronization setting may indicate that the event in the first datastore is to be synchronized with a corresponding event in the second datastore. Alternatively, synchronization setting may indicate that the first datastore obtains from the second datastore an update to the information of the event, adds the update to the event, and synchronizes the event based on the updated event.

In a second aspect of the invention, a computer program product is provided. The computer program comprises instructions for selecting a first datastore comprising a plurality of events in response to a user's input, instructions for selecting a second datastore in response to the user's input, and instructions for providing a synchronization setting for an event in the plurality of events so as to indicate how synchronization between the first datastore and the second datastore is to be performed with respect to the event.

In a third aspect of the invention, a device is provided. The device comprises means for selecting a first datastore comprising a plurality of events, means for selecting a second datastore, and means for providing a synchronization setting for an event in the plurality of events so as to indicate how synchronization between the first datastore and the second datastore is to be performed with respect to the event.

In a forth aspect of the invention, another method is provided. The method comprises the steps of selecting, in a first datastore, an event comprising information of the event, providing to a second datastore the information of the event, obtaining from the second datastore an update to the information and adding the update to the event, and synchronizing the first datastore and the second datastore with respect to the event based on the updated event in the first datastore.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a prior-art event management scheme;

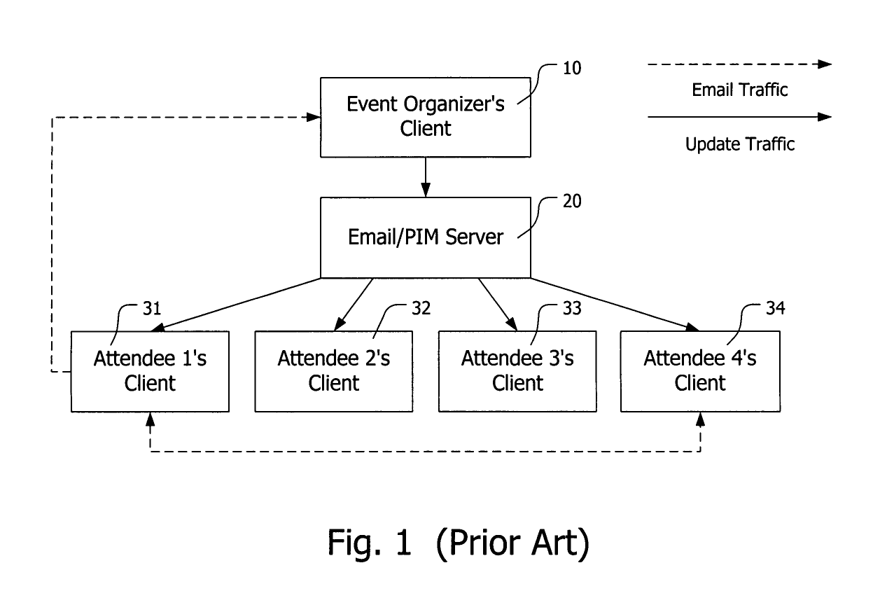

FIG. 2 is a flow diagram illustrating a process of creating an event entry and selecting synchronization settings for the event, according to the present invention;

FIG. 3 is a block diagram of an event management scheme according to the present invention;

FIG. 4 is a schematic structure of an event entry in prior-art PIM applications;

FIG. 5 is a schematic structure of an event entry according to the present invention; and

FIG. 6 is a flow diagram of an exemplary meeting event, according to the present invention.

### DETAILED DESCRIPTION OF THE INVENTION

This invention relates in particular to two aspects of data synchronization. The first aspect is synchronizing an event between two or more datastores managed by the same person (including the person's assistants or delegates). The second aspect is, for an event such as a meeting that involves a plurality of participants, sharing and updating event information by synchronizing the event in participants' datastores.

The present invention can be implemented in any software that manages personal information on a network-enabled client device. The software has functionalities that allow for data synchronization between two client devices (point-to-point) and data sharing among a plurality of client devices (point-to-multipoint).

The invention is explained below with regard to illustrative examples. It is assumed that a user has a local client device A and a remote client device B. The local client A can be the user's PC, where a datastore containing calendar and event information is located either in the PC or, more typically, in a centralized email/PIM file server that the PC is in communication with. One example of a server-based datastore is a Calendar datastore in a MICROSOFT EXCHANGE SERVER®, managed by MICROSOFT® OUTLOOK®. The remote client B may be a mobile terminal having a local datastore.

In explaining the second aspect of the invention, it is further assumed that the user is a meeting organizer who sets up a meeting event in the datastore of the local client A or the remote client B and shares meeting-related information with one or more participants. A participant has at least one network-enabled client device that connects to a PIM datastore, so that the meeting-related information is shared between the organizer and the participant by synchronizing the event between the organizer's datastore(s) and the participant's datastore(s).

1. Synchronization Settings

The invention provides, in one embodiment, a list of synchronization settings for an event, so that the PIM software performs synchronization tasks, with respect to the event, according to one of the settings chosen by the owner/manager of the event.

An event entry in a PIM datastore contains one or more data fields. When setting up an event using the PIM software, a user enters data to one or more fields of the entry, such as time, date, subject, etc. The user can set this event to be synchronizing with a corresponding event entries in another datastore. The user may set a time interval between two synchronization operations, so that the synchronization operations are repeated according the time interval. Or, the user may initialize a synchronization operation manually. The user can also select one synchronization method to synchronize this particular event with each of the corresponding events in other datastores. The selection is non-conflicting, i.e. if one datastore (or the client device that hosts the datastore) is set to “win” the synchronization for the event, the other datastores or clients will automatically “lose” the synchronization.

A setting can be replaced by another setting after the event entry is created.

Preferably, only the event owner or the owner's delegate can modify the setting. A setting can be selected for all the synchronization tasks of the event, or it can be used for one synchronization task only. If no setting is selected, the event is assigned a default setting, such as “New Data Replaces Old Data,” in which case the winner is not determined by the client (or datastore) but by the time sequence.

Synchronization settings include:
This Client Always Wins
This Client Wins The Next Synchronization
Remote Client Always Wins
Remote Client Wins The Next Synchronization
Append
Append, Group
Absolute Winner

Note that the term “Client” in the above list has the same meaning as the datastore the client device is associated with.

Each setting is only applicable to the event it is associated with. Following is a further explanation of the above settings.

This Client Always Wins:

A user may use this setting on a current device to win synchronization over other devices for a particular event. For instance, the user may have already set the PIM application with a setting that allows for a local device (e.g. a PC) to win synchronization in all other events in the datastore, because the user mainly edits the PIM information on the PC. For this particular event, however, all the modifications would typically occur while on the move (e.g. on a mobile client). Therefore, while all the other events are ‘normal’ events, this event is exceptional and is assigned a different setting.

This Client Wins the Next Synchronization:

This setting has the same effect as the above setting, but it is effective for one synchronization task only. This setting can be used in special situations where all modifications to an event occur on another device that has been set to “win,” but the user decides to modify the event on the current device and let the modification be carried over to the default device. Since the setting is temporary, the PIM returns to the previous setting after the next synchronization.

Remote Client Always Wins:

If a local client is a land-based device (PC or server) and a remote client is a mobile device, this setting is equivalent to a “Mobile Client Always Wins” setting for this particular event. However, in a broader sense, any client can be considered as a remote client or a local client, whether or not the remote client is a mobile device is irrelevant. This setting, for instance, can be used by a remote client user who is the owner of an event to restrict a user of the current client from modifying the event. Under this setting, the current (local) device user can edit the event, but the original content, owned by the user of the remote client, is maintained. For example, a supervisor sets a task on a client A (a “remote” client), modifies it, synchronizing a subordinate's client, client B, with the client A. With this setting, the task content on client B is ‘read-only’ to the subordinate.

In the case of point-to-multipoint synchronization, it is necessary for the event owner to further specify which remote client is the winner, and all other clients are otherwise non-winners.

Remote Client Wins The Next Synchronization:

Accordingly, this setting has the same effect as the above setting but only for one synchronization. For example, a user has edited an event in the current client, client B, but later realizes that the modification was incorrect. Therefore, by using this setting, the user obtains a chance to restore the old data from previous synchronization from the other client, client A. (In this case client A is a “remote” client to client B.)

Also, an owner of an event can use this setting to grant temporary modification rights to another user on a remote device, so that the other user can make changes to the event and synchronize the changes back to the owner's device.

Append:

This setting allows for preservation of all the changes to an event. Under this setting, synchronization is performed in a manner similar to the “Track Change” function of MICROSOFT® Word. If a user modifies an event in client A (without synchronizing the data to client B), then edits the same event in client B, by using this setting the user is able to synchronize the event with all the changes made on both client A and client B.

A synchronization operation under the “Append” setting has two steps. The first step is for a first device to capture the event content in a second device that is different from the event content in the first device and append the different content to the event. The second step is to synchronize the event in the second device with the appended event in the first device.

Append, Group:

The setting has the effect of the “Append” setting, but involves multiple users or clients. This setting also has two steps. The first step is for a first device to capture the event content in a second device that is different from the event content in the first device and append the different content to the event, then capture the event content in a third device that is different from the event content in the first device and append the different content to the event, and so on. The second step is to synchronize the event in all other devices with the appended event in the first device.

This setting is particularly applicable for an event entry that has corresponding entries in more than one client owned by more than one user. It is especially useful for preserving and sharing event-related information among the users. A particular example of using this setting is meeting management. This setting will be described in more detail with regard to the meeting event example in succeeding sections.

Absolute Winner:

This setting makes the event entered on the current client device the winner in all situations. It allows only one client of a network (typically the mobile terminal, or, in a workgroup environment, the client that has the controlling power over the event) to keep the modified event content and synchronize it to all clients. This setting differs from the above-presented “This Client Always Wins” setting in that once the “absolute winner” is set, it cannot be overridden by any other settings from any other devices. It can only be deselected by the original owner of the event.

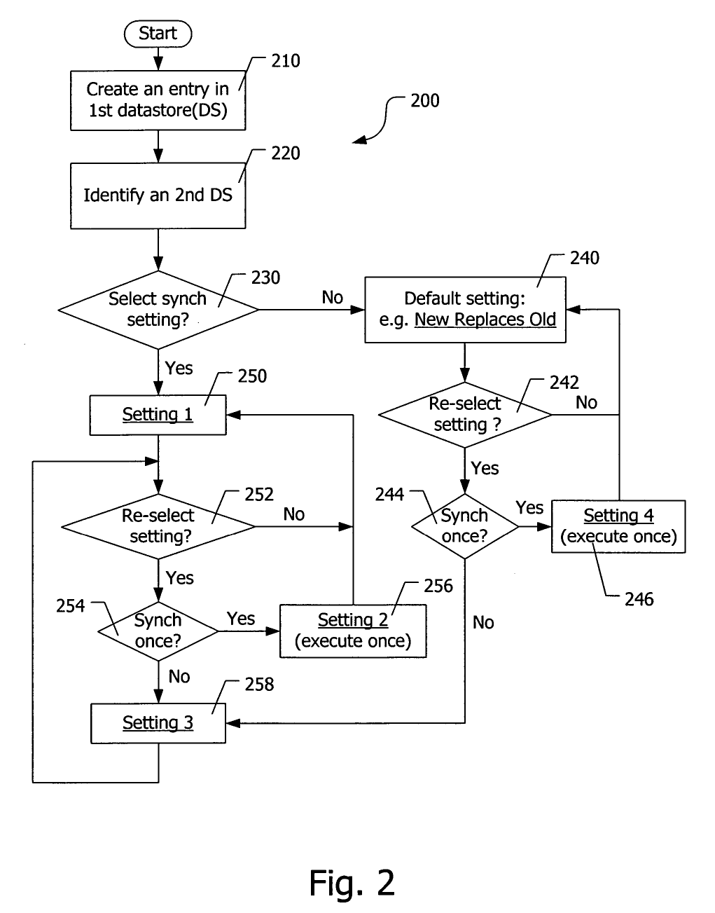

FIG. 2 is a flow diagram illustrating a process 200 according to the above-described embodiment of the present invention. In a step 210, the user creates an event entry in the datastore of client or server A. In a step 220, the user identifies a second datastore in a client or server B for synchronizing the event with. In a step 230, the user has a choice of selecting a synchronization setting for the event. If no setting is selected, the event is synchronized, in a step 240, between A and B by a default rule, such as “New Data Replaces Old Data.” This default setting can be changed later on, in a step 242, to a new setting. If the new setting is just for the next synchronization (step 246, Setting 4), the event returns to the default setting after next synchronization, otherwise, in a step 258, the event is assigned a new setting (Setting 3) until next change of settings.

If, at the time of creating the event, a synchronization setting (Setting 1) is selected in a step 250, the event is synchronized between A and B according to the setting. This setting can be changed later on, in a step 252, to a new setting. If the new setting is just for the next synchronization (step 256, Setting 2), the event returns to the previous setting (Setting 1) after next synchronization, otherwise, in a step 258, the event is assigned a new setting (Setting 3) until next change of settings.

In implementing the synchronization settings of the present invention, it is also possible to further define the availability of settings in different phases or conditions of the event. Some of the settings described above may only be available in certain phases or conditions, such as, only when the event entry is created, only when using one particular client device (typically a mobile client), only when the supervisor logs in and opens the datastore, or only when the authorized user logs in and opens the datastore, etc.

It is noted that some of the above settings can also be used as the default settings in alternative embodiments of the invention. The scope of the present invention is not limited by one particular embodiment as presented above.

2. Application of Synchronization Settings in Event Management

One of the applications of the synchronization settings according to the present invention is in event management. An event may be a meeting, a task, or a variety of other activities that involve at least two parties. Although a meeting event is exemplified hereafter, it is noted that the scope of the present invention is not limited to any specific type of event.

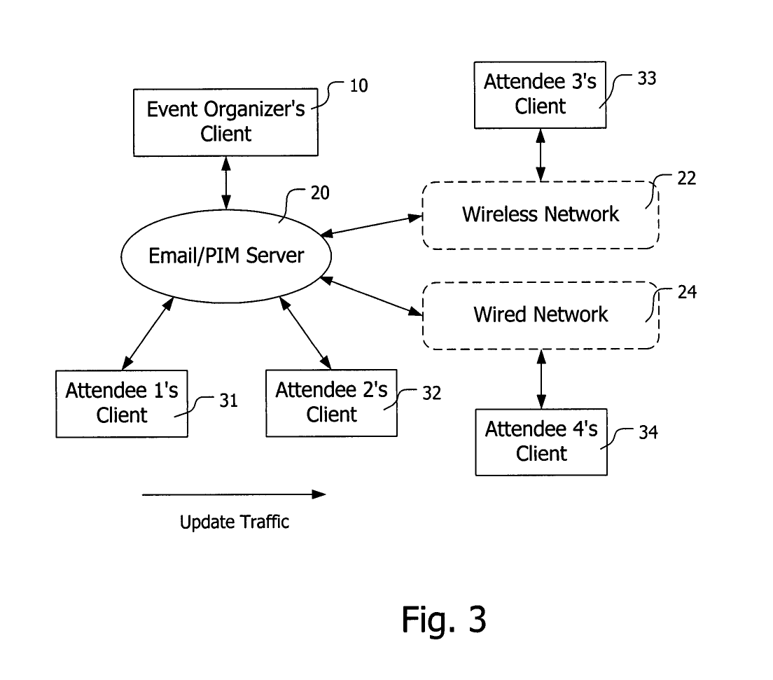

A meeting event is typically scheduled and assigned to a group of people by an organizer. Referring now to FIG. 3, an organizer creates a meeting event in a datastore. The event entry normally comprises a set of fields that contain modifiable data. The organizer inputs data into the fields such as date, time, duration, topic, etc. The datastore of the organizer may be located in the organizer's client 10 or in an email/PIM server 20. The organizer then sends the meeting schedule and agenda to a group of participants, typically via an email distribution list or individual emails. (Attendees 1, 2, 3, and 4 are shown in FIG. 3, some of which may be directly connected to the organizer's email/PIM server 20, others may be connected to the organizer's email/PIM server via a wireless network 22 or a wired network 24.) If a participant accepts the invitation, a corresponding event in his/her own datastore (in client devices 31, 32, 33, and 34, or server 20) is created, either by the participant or by the organizer. At the time of setting up the meeting, the organizer 10 can choose a suitable synchronization setting for each datastore that has a corresponding event. Particularly, if the organizer uses the “Append, Group” setting for the event and specifies the group members (a group can include some or all of the meeting participants), the event is updated among the group members such that all information contributed by the group members is saved in the event entry in the organizer's datastore as well as in the group members' datastores.

3. Event Entry Content Structure

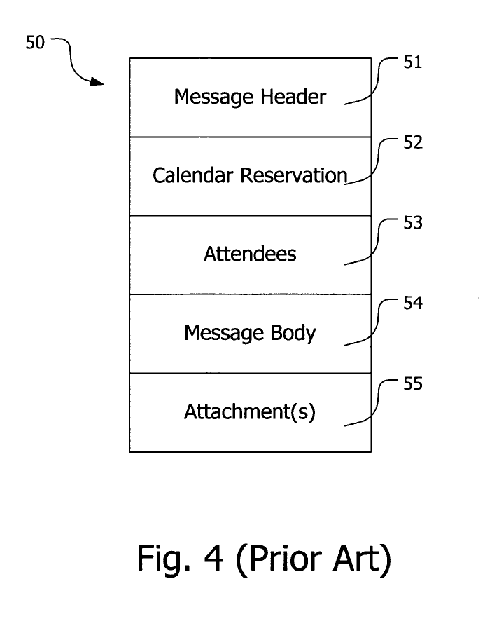

A schematic structure of an event entry commonly used in prior art PIM applications is shown in FIG. 4. The entry 50 contains a plurality of fields such as message header 51, calendar reservation 52 (containing information such as date, time, duration, etc.), list of attendees 53 (or concerned parties), message body 54 and attachment(s) 55. A field may be further divided into sub-fields.

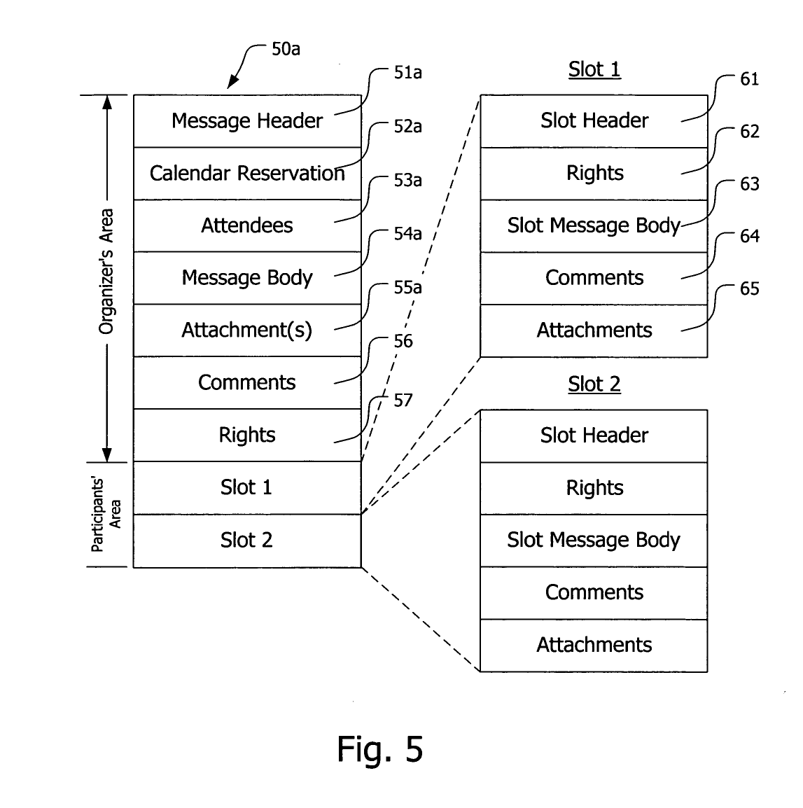

With the present invention, the structure of an event entry is expanded. FIG. 5 shows a structure of an event entry according to one embodiment of the present invention. When making a reservation for a meeting, for example, an organizer can use a part of the entry 50a, labeled as “Organizer's Area,” to establish basic information about the meeting. The fields established by the organizer include fields such as message header 51a, calendar reservation 52a (containing logistic information such as date, time, duration, etc.), list of attendees 53a (or concerned parties), message body 54a, attachment(s) 55a, comments 56. In addition, the organizer can utilize a “rights” field 57 to define organizer's rights in information updating/sharing among the organizer and the participants.

In addition to organizer's entry, supplementary fields are reserved by the organizer for the participants to add their own information (the “Participants' Area” in FIG. 5). In one embodiment of the invention, a participant may be assigned one or more “slots,” a slot is composed by one or more fields, in which the participant can add notes, attachments, links, etc. and share the slots with the organizer and other participants. The participant may also create sub-slots within a slot. A structure of a slot is also shown in FIG. 5 and it may include fields such as a slot header 61, access rights 62 assigned by the organizer, a slot message body 63, comments 64 and attachment(s) 65.

In alternative embodiments of the invention, an event entry may be constructed to include a reserved field for all the participants who are given the rights to submit comments and proposals. The field can be structured like a discussion group, where all discussion posts are added, sorted by time of submission and shared with other participants.

To enable information sharing and synchronous updating between the organizer's event entry and participants' event entries, the following parameters must be set when the organizer originates an event:

1) Organizer's Datastore Location
All the participants' events are synchronized with the organizer's event at the datastore indicated. This datastore location may be defined in a sub-field of the “calendar reservation” field 52.

2) Password for Allowing Modification of the Entry (Optional)
A password may be set by the organizer so that only an authorized user can log into the datastore and modify the event.

3) Access Rights Given to a Participant
The organizer may set access rights for a slot that is assigned to a participant. Some or all of the following rights may be assigned to a participant, and rights may vary by the participant. Such rights include:
   Creating new slot;
   Modifying content of a slot;
   Consuming content of a slot;
   Sending updates to a slot;
   Choosing update mode;
   Sending comments to another slot that is read-only; and
   Granting other participants access rights to a slot.
      4. Delivery of Updates

Updates made by a participant in his/her own slot(s) will be first saved locally to the participant's own datastore. Upon finishing editing the slot, the participant is prompted by the PIM application with options such as “Send Update?” If the participant presses the Send Update (Yes) button, the modified content in the slot is sent to the organizer at the specified organizer's datastore location and appended to the same slot in the organizer's event entry. Otherwise, if the participant does not send the update to the organizer but keeps the modified content at the local datastore, the organizer will capture and append the modified content at the next update. At the time of the update, the organizer will acquire all updates by all contributing participants, append them in the appropriate fields of the event entry and send the updated entry to all or selected participants. Also, at any time, a participant may send a query to the organizer's datastore, asking for an update. The organizer's datastore, upon receiving such a query, initializes an update operation that appends all updates from all contributing participants.

The synchronous update directed by the “Append, Group” setting generally applies only to the fields that are in the information part of the event entry, not to the fields that contain logistic data of the entry. The logistic data is maintained and updated only by the meeting organizer or the organizer's delegate.

The updates may be delivered to a participant along with a notification, e.g. an email message, a pop-up message or a sound alert. The notification feature can be set selectively, so that some of the updates are delivered “silently” and others are delivered “loudly.” The silent delivery is a desirable mode when there are a lot of “voluntary” participants or when the information entered is considered non-urgent, not requiring immediate actions or it is of FYI (for your information) kind. A party may switch on and off the silent update feature if the party is granted the right, but some of the updates (e.g. important ones) will always be delivered “loudly”, i.e. with the notification.

A party may have the right to define the importance of an update at the time the update is sent. As such, the party may be provided with rights to send the updates with a “High Importance” label, in which case the receiving parties are always notified of the update.

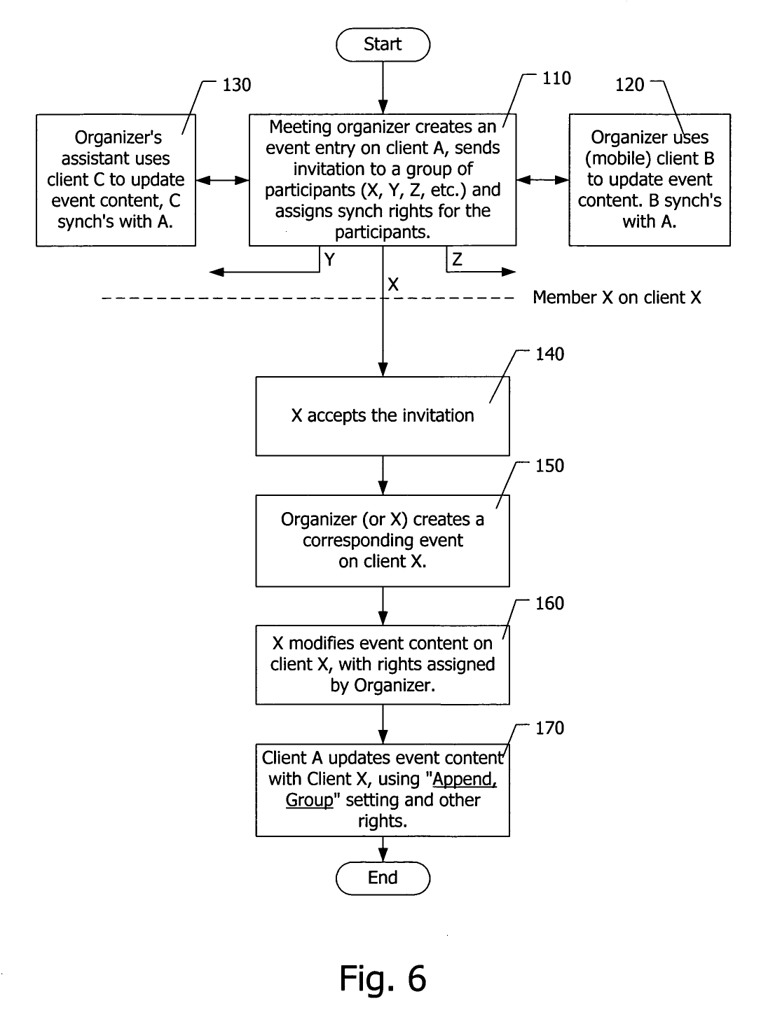

FIG. 6 is a flow diagram of a meeting event according to the present invention. In a step 110, a meeting organizer creates an event entry for a meeting including one or more fields for logistic data and information in the PIM datastore of client A. The organizer sends invitation or announcement of the event to a list of participants (X, Y, Z, etc.) and assigns synchronization rights for the participants. Meanwhile, in a step 120, the organizer sets up a mobile client B to synchronize with client A so that the organizer can also use the mobile client B to update the event information. The organizer, in a step 130, may also delegate an assistant to maintain the event (e.g. sending reminders, updating participant list, etc.). The assistant uses client C to update the event content. Client C is setup to synchronize with client A. In a step 140, a group member X on client X receives the meeting invitation. Member X is able to accept the invitation to participate the meeting. (Participation includes monitoring, overseeing, etc.) Therefore, in a step 150, a corresponding event is created in client X's datastore, by member X or the organizer. In a step 160, member X modifies event content on client X (e.g. adding comments, file attachments, etc.) with rights assigned by A. In a step 170, client X synchronizes the event content with A using the “Append, Group” setting, so that the changes made by member X is appended to event entry of client A and, further, to other group members' events.

Thus, and summarizing, the invention provides a PIM application with enhanced interaction possibilities. Various settings are provided for synchronizing PIM data among network-enabled client devices. With the invention, a synchronization setting is provided for an event in a client device's datastore, and the setting can be modified so that the synchronization is carried out as desired. The invention is not only applicable in synchronizing information between different devices used by a same user, but also applicable in sharing information with respect to an event among a plurality of users. The invention provides a number of new features, including a mechanism for silently updating information related to an event.

A PIM application implementing the invention is more flexible in managing scheduled events than a PIM application of the prior art. For events such as meetings, because all the information relating to a event can be found under one datastore entry, a user's capability of preparing, updating and commenting of the materials related to the event is greatly enhanced. Also, with this invention, the capabilities for the event participants to interact with each other are improved.

The invention is not limited to a certain type of device or a certain type of software that the devices use for PIM functionality. With a proper implementation, the invention is applicable to a wide range of network-enabled devices, such as PDAs, laptop PCs, desktop PCs, mobile electronic devices, etc. Further, the invention is not limited to one particular type of network connection.

The present invention has been disclosed in reference to synchronizing event information between two datastores and sharing information of a scheduled event among a plurality of clients. Numerous modifications and alternative arrangements may be devised by those skilled in the art without departing from the scope of the present invention, and the appended claims are intended to cover such modifications and arrangements.

What is claimed is:

1. A method, comprising the steps of:
selecting a first datastore comprising a plurality of events;
selecting a second datastore; and
providing a synchronization setting for an event in the plurality of events so as to indicate how synchronization between the first datastore and the second datastore is to be performed with respect to the event.

2. The method of claim 1, wherein the synchronization setting indicates that a corresponding event in the second datastore is to be synchronized with the event in the first datastore.

3. The method of claim 1, wherein the synchronization setting indicates that the event in the first datastore is to be synchronized with a corresponding event in the second datastore.

4. The method of claim 1, wherein the event in the first datastore comprises one or more data fields, and wherein synchronization between the first datastore and the second datastore with respect to the event comprises synchronizing a data field of the event with a corresponding data field of a corresponding event in the second datastore according to the synchronization setting.

5. The method of claim 4, wherein the event comprises a plurality of fields and the plurality of fields includes a field indicating rights of one or more users to change one or more of the data fields.

6. The method of claim 5, wherein a main set of the plurality of fields is updateable by a main user, and wherein at least one subset of the fields is updateable by a different user.

7. The method of claim 6, wherein the plurality of fields includes a plurality of subsets of fields each updateable by a respective different user.

8. The method of claim 2, wherein the event comprises information associated with the event and the method further comprises:
a step of providing to the second datastore the information associated with the event;
a step of obtaining from the second datastore an update to the information and adding the update to the event; and
a step of synchronizing the event based on the updated event.

9. The method of claim 8, wherein the event in the first datastore comprises at least one data field, and wherein,
the step of providing to the second datastore the information associated with the event comprises providing to the second datastore a corresponding event comprising at least one corresponding data field, and
the step of obtaining from the second datastore an update to the information and adding the update to the event comprises obtaining from the second datastore information in a corresponding data field of the corresponding event that is different from the information in the data field of the event and adding the different information to the data field.

10. The method of claim 1, wherein the first datastore or the second datastore is associated with a device.

11. The method of claim 1, wherein the event is associated with a user, and the steps of selecting a second datastore and providing a synchronization setting for the event are performed in response to the user.

12. A computer program product, comprising a computer readable storage structure embodying computer program instructions for a computer processor, said computer program comprises:
instructions for selecting a first datastore comprising a plurality of events in response to a user's input;
instructions for selecting a second datastore in response to the user's input; and
instructions for providing a synchronization setting for an event in the plurality of events so as to indicate how synchronization between the first datastore and the second datastore is to be performed with respect to the event.

13. The computer program product of claim 12, wherein the event comprises one or more data fields, and the program further comprises instructions for synchronizing a data field of the event with a corresponding data field of a corresponding event in the second datastore according to the synchronization setting.

14. The computer program product of claim 12, wherein the event comprises information associated with the event, and the program further comprises:
instructions for providing to the second datastore the information associated with the event;
instructions for obtaining from the second datastore an update to the information and adding the update to the event; and
instructions for synchronizing the event based on the updated event.

15. The computer program product of claim 14, wherein the event in the first datastore comprises at least one data field, and wherein,
the instructions for providing to the second datastore the information associated with the event comprises instructions for providing to the second datastore a corresponding event comprising at least one corresponding data field, and
the instructions of obtaining from the second datastore an update to the information and adding the update to the event comprises instructions for obtaining from the second datastore information in a corresponding data field of the corresponding event that is different from the information in the data field of the event and adding the different information to the data field.

16. The computer program product of claim 12, wherein the program is associated with a client device and said client device is associated with the first datastore or the second datastore.

17. A device, comprising:
means for selecting a first datastore comprising a plurality of events;
means for selecting a second datastore; and
means for providing a synchronization setting for an event in the plurality of events so as to indicate how synchronization between the first datastore and the second datastore is to be performed with respect to the event.

18. The device of claim 17, wherein the event in the first datastore comprises one or more data fields, and the device further comprises means for synchronizing a data field of the event with a corresponding data field of a corresponding event in the second datastore according to the synchronization setting.

19. The device of claim 17, wherein the event comprises information associated with the event and the device further comprises:
means for providing to the second datastore the information associated with the event;
means for obtaining from the second datastore an update to the information and adding the update to the event; and
means for synchronizing the event based on the updated event.

20. The device of claim 19, wherein the event in the first datastore contains at least one data field, and wherein,
the means for providing to the second datastore the information associated with the event comprises means for providing to the second datastore a corresponding event comprising at least one corresponding data field, and
the means for obtaining from the second datastore an update to the information and adding the update to the event comprises means for obtaining from the second datastore information in a corresponding data field of the corresponding event that is different from the information in the data field of the event and adding the different information to the data field.

21. A method, comprising the steps of:
selecting, in a first datastore, an event comprising information of the event;
providing to a second datastore the information of the event;
obtaining from the second datastore an update to the information and adding the update to the event; and
synchronizing the first datastore and the second datastore with respect to the event based on the updated event in the first datastore.

22. The method of claim 21, wherein the event in the first datastore comprises at least one data field, and wherein,
the step of providing to the second datastore the information of the event comprises providing to the second datastore a corresponding event comprising at least one corresponding data field, and
the step of obtaining from the second datastore an update to the information and adding the update to the event comprises obtaining from the second datastore information in a corresponding data field of the corresponding event that is different from the information in the data field of the event and adding the different information to the data field.

23. A computer program product, comprising a computer readable storage structure embodying computer program instructions for a computer processor, said computer program comprises:
instructions for selecting, in a first datastore, an event comprising information of the event;
instructions for providing to a second datastore the information of the event;
instructions for obtaining from the second datastore an update to the information and adding the update to the event; and
instructions for synchronizing the first datastore and the second datastore with respect to the event based on the updated event in the first datastore.

24. The computer program product of claim 23, wherein the event in the first datastore comprises at least one data field, and wherein,
the instructions for providing to the second datastore the information of the event comprises instructions for providing to the second datastore a corresponding event comprising at least one corresponding data field, and
the instructions for obtaining from the second datastore an update to the information and adding the update to the event comprises instructions for obtaining from the second datastore information in a corresponding data field of the corresponding event that is different from the information in the data field of the event and adding the different information to the data field.

25. A device, associated with a first datastore, comprising:
means for selecting, in the first datastore, an event comprising information of the event;
means for providing to a second datastore the information of the event;
means for obtaining from the second datastore an update to the information and adding the update to the event; and
means for synchronizing the first datastore and the second datastore with respect to the event based on the updated event in the first datastore.

26. The device of claim 25, wherein the event in the first datastore comprises at least one data field, and wherein,
the means for providing to the second datastore the information of the event comprises means for providing to the second datastore a corresponding event comprising at least one corresponding data field, and
the means for obtaining from the second datastore an update to the information and adding the update to the event comprises means for obtaining from the second datastore information in a corresponding data field of the corresponding event that is different from the information in the data field of the event and adding the different information to the data field.
